(19) United States
(12) Patent Application Publication
(10) Pub. No.: US 2019/0204117 A1
(43) Pub. Date: Jul. 4, 2019

(54) ROTARY SWITCH FOR A MOTOR VEHICLE

(71) Applicant: ZF Friedrichshafen AG, Friedrichshafen (DE)

(72) Inventors: Alexander Kirilenko, Diepholz (DE); Alex Hessel, Lemforde (DE); Torsten Aumann, Drentwede (DE)

(73) Assignee: ZF Friedrichshafen AG, Friedrichshafen (DE)

(21) Appl. No.: 16/326,807

(22) PCT Filed: Jul. 17, 2017
(86) PCT No.: PCT/EP2017/067983

§ 371 Date: Feb. 20, 2019

(30) Foreign Application Priority Data
Aug. 23, 2016 (DE) 10 2016 215 789.2

(51) Int. Cl. G01D 5/347; F16H 59/08

(52) U.S. Cl. CPC G01D 5/3473; F16H 2059/081; G01D 5/34792; F16H 59/08

(57) ABSTRACT

The invention relates to a rotary switch (1) for a motor vehicle that has a rotational position detection device, wherein the rotational position detection device has at least a first light-based transmitter/receiver pair (5a), a second light-based transmitter/receiver pair (5b), and a light screening element (15), wherein the light-based transmitter/receiver pairs (5a, b) each have a light transmitter and a light receiver located opposite the light transmitter, such that a light transmission path (27) is formed between each transmitter and receiver, wherein the light screening element (15) determines the transmission properties of the respective light transmission paths (15) based on the rotational positions (D, N, R) of the rotary switch (1), wherein the transmitter/receiver pairs (5a, b) are configured such that a first spacing (d1) extending between a midpoint of the first light transmission path (27a) of the first pair (5a) and a rotational axis (9) of the rotary switch (1) differs from a second spacing (d2) extending between a midpoint of the second light transmission path (27b) of the second pair (5b) and the rotational axis (9).

The invention relates to a rotary switch for a motor vehicle that has a rotational position detection device, wherein the rotational position detection device has at least a first light-based transmitter/receiver pair, a second light-based transmitter/receiver pair, and a light screening element, wherein the light-based transmitter/receiver pairs each have a light transmitter and a light receiver opposite the light transmitter, such that a light transmission path is formed in each case between the transmitter and the receiver, wherein the light screening element is used to determine the transmission properties of the respective light transmission paths based on the rotational position of the rotary switch.

A rotary switch of this type is described in the German patent application DE102013224258A1. This rotary switch has a light screening element that encompasses the rotational axis of the rotary switch in the form of a circular wall. This wall has openings in it that allow light signals from electric eyes to pass through, or blocks these light signals, depending on the rotational position of the rotary switch. The rotational position of the rotary switch is thus determined on the basis of the electrical signals generated by the electric eyes.

The transmitter/receiver pairs are normally mounted directly on a printed circuit board with such rotary switches, in order to avoid complex wirings and other production-oriented complications. The printed circuit boards must thus reflect or cover the surfaces occupied by the screening element, such that the transmitter/receiver pairs, e.g. electric eyes, can be placed accordingly. The printed circuit boards must thus either be tailored precisely or be larger than would be necessary for the typical amount of electric and/or electronic components needed for the functioning of the rotary switch. Both the tailoring as well as the losses of printed circuit board surface areas represent an economic loss. Furthermore, these printed circuit boards require more structural space.

The object of the invention is thus to present a rotary switch that makes more efficient use of the surface area of the printed circuit board, or has a more compact structure, respectively.

This object is achieved by a rotary switch according to claim 1. Advantageous further developments are the subject matter of the dependent claims.

This object is thus achieved with a rotary switch for a motor vehicle that has a rotational position detection device, wherein the rotational position detection device has at least a first light-based transmitter/receiver pair, a second light-based transmitter pair, and a light screening element, wherein the light-based transmitter/receiver pairs each have a light transmitter and an opposing light receiver, such that a light transmission path is formed in each case between the transmitter and the receiver, wherein the light screening element is used to determine the transmission properties of the respective light transmission paths on the basis of the rotational position of the rotary switch, wherein the transmitter/receiver pairs are located such that a first spacing extending between a midpoint of the first light transmission path of the first pair and a rotational axis of the rotary switch differs from a second spacing extending between a midpoint of the second light transmission path of the second pair and the rotational axis.

A rotary switch can be understood to be a rotary switch for selecting a gear setting for a vehicle transmission. A light-based sensor can be a light emitting diode, for example. A light-based receiver can be a phototransistor, for example. A transmitter/receiver pair can be designed as an electric eye. The light transmission path can exhibit an optical modification as a result of a change in the rotational position of the rotary switch. The rotational position detection device is used to determine a setting of the rotary switch.

The rotary switch can thus be configured such that the printed circuit boards only need to cover or reflect a fraction of the surface area of the light screening element, because the transmitter/receiver pairs can be offset to one another, or installed or placed behind one another. This provides for a flexibility and variability in the configuration of a printed circuit board layout for a rotary switch. This results in savings in production costs and simplifications in the manufacturing process.

The light screening element can be configured to block a light signal transmitted by the respective transmitter along the respective light transmission path or allow it to pass, i.e. to interrupt or open the light transmission path, at different spacings to the rotational axis, depending on the setting of the rotary switch. In other words, in a first setting of the rotary switch, the light transmission path is used to transmit a light signal from the transmitter to the receiver, and in a second setting of the rotary switch, the light screening element blocks the light transmission path, in order to prevent transmission of the light signal from the transmitter to the receiver.

The rotary switch is advantageously configured such that the light screening element has a first screening wall, which is concentric to the rotational axis of the rotary switch, wherein the screening wall at least partially encircles the rotational axis and determines the transmission property of the first light transmission path of the first light-based transmitter/receiver pair, depending on the rotational position, wherein the light screening element has a second screening wall that is concentric to the rotational axis of the rotary switch, wherein the second screening wall at least partially encircles the rotational axis, and is at a different spacing to the rotational axis than the first screening wall, and determines the transmission property of the second light transmission path of the second light-based transmitter/receiver pair, depending on the rotational position.

The screening walls, which are concentric to the rotational axis, can have regions that determine different transmission patterns, such that in certain rotational positions, the transmission properties of the individual light transmission paths are different.

In an advantageous configuration of the rotary switch, the light screening element can move in relation to the light-based transmitter/receiver pairs, wherein the relative movement is a rotational movement.

In one embodiment of the rotary switch, the first transmitter/receiver pair and the second transmitter/receiver pair are located along different radial directions in relation to the rotational axis. The transmitter/receiver pairs can thus be stacked, wherein the radial spacing, for example, from a first receiver to the rotational axis corresponds to the radial spacing of the second transmitter to the rotational axis. The transmitter/receiver pairs can thus be stacked, such that an interfering signal from the first or second transmitters cannot reach the second or first receivers. As a result, the rotary switch can be compact, and the printed circuit board surface areas can be used efficiently, without compromising the functioning thereof.

In one embodiment of the rotary switch, the first transmitter/receiver pair is located substantially radially between the second transmitter/receiver pair and the rotational axis. As a result, the printed circuit board surface area can be kept small, because the smallest possible angular range of the rotary switch needs to be covered.

In one embodiment of the rotary switch, at least one of the screening walls has sections with different transmission properties, in particular wherein the at least one screening wall has alternating sections allowing light to pass through and blocking light, wherein the sections have different effects on the transmission properties of the respective light transmission paths, depending on the different rotational positions. The screening walls are configured such that when the light screening element is rotated about the rotational axis, the sections of the screening wall that have different transmission properties intersect the light transmission paths. As a result, the sections that allow light to pass and the sections that block light intersect the light transmission paths in an alternating sequence.

In a further development, the light screening element is configured to determine the transmission properties of the respective light transmission paths in that the first and second screening walls block or open the light transmission paths based on the rotational position, such that each rotational position can be identified on the basis of a unique combination of open or blocked light transmission paths.

A first section with a first transmission property can be located between the transmitter and the receiver when the rotary switch is in a first rotational position. A second section with a second transmission property can be located between the transmitter and the receiver when the rotary switch is in a second rotational position. Because of the different transmission properties, light can strike the receiver with a higher intensity when it is in a first rotational position, and strike the receiver with a lower intensity when it is in the second rotational position. This makes it possible to distinguish clearly between the two rotational positions. In particular, the electric signals of the receiver can have unique dedicated signal patterns for each of the rotational positions. The first transmission property can be transparent, for example, and the second transmission property can be opaque. As a result, the first section functions similar to a window, wherein the light transmission path is unobstructed in the first rotational position.

A third section with a third transmission property, differing from the first and second, is also conceivable.

In a further development, each unique combination can be represented by a bit sequence, wherein the Hamming spacing between the respective bit sequences representing the combinations has a value of at least 2.

Numerous rotational positions can be represented as vectors in a matrix comprising rows and columns. The bit sequences that represent combinations can be stored in an evaluation unit. The electric signals of the receiver can be converted to digital values by means of an A/D converter, and compared with the stored bit sequences in the evaluation unit, in order to determine a current rotational position.

In an advantageous embodiment, the light-based transmitter is configured to transmit an infrared light signal, and the light-based receiver is configured to receive the infrared light signal. An optical determination of the rotational position can thus be carried out advantageously, without coming in contact therewith.

In the approach presented herein, light is used, in particular infrared light, for detecting the rotational position of the rotary switch. The light can display large intensity fluctuations in a small space, by means of which boundaries can be established between individual rotational positions.

In an advantageous embodiment, the rotary switch is integrated in a device for selecting a gear setting in a motor vehicle.

A device can be an electric device that processes electrical signals, e.g. the receiver signals, and outputs control signals based thereon. The device can have one or more interfaces, which can be in the form of hardware and/or software. In the form of hardware, the interfaces can be part of a circuitry, for example, in which the functions of the device are implemented. The interfaces can also be a distinct, integrated circuit or be at least partially comprised of discrete components. If they are software-based, the interfaces can be software modules present, e.g. on a microcontroller, in addition to other software modules.

The flexibility of the rotary switch described above allows for a high level of reliability in detecting the rotational position, in particular with a configuration in which the Hamming spacing between the encodings of individual rotational positions is at least two. Such a rotary switch is particularly suitable for use in a device for selecting a gear setting, because this requires a safety integrity level defined by a safety standards organization.

The invention shall be explained in greater detail below based on the attached drawings. Therein:

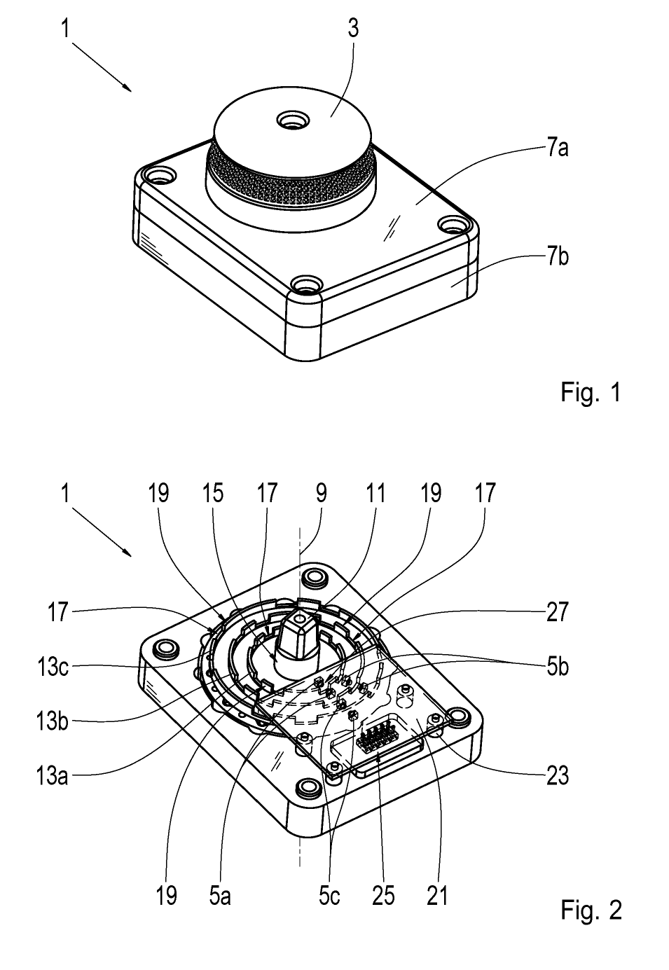

FIG. 1: shows a perspective view of an embodiment of a rotary switch according to the invention;

FIG. 2: shows a perspective view of the internal construction of the embodiment shown in FIG. 1;

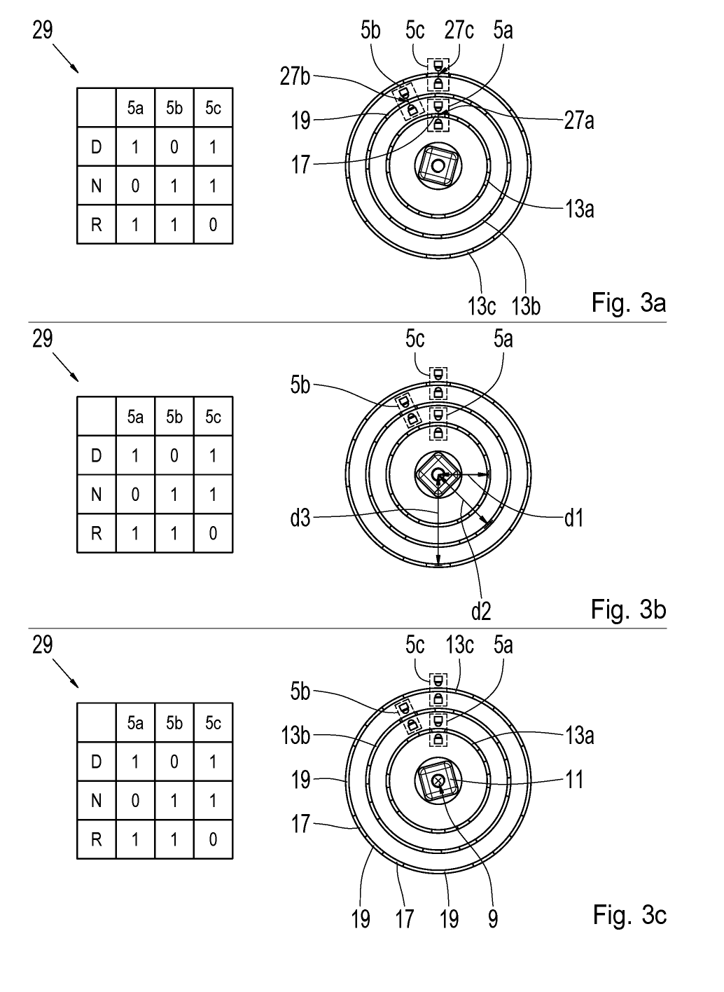

FIG. 3a, b, c: show a top view of an embodiment of a rotary switch in a first, second, and third rotational position, and tables listing the respective rotational positions based on the respective receiver signals.

FIG. 1 shows a perspective view of an embodiment of a rotary switch 1 according to the invention. The rotary switch 1 has a knob 3. The knob 3 can be rotated to select a setting. The rotary switch 1 also has a housing 7. The housing 7 is composed of two parts 7a, 7b. Such rotary switches 1 are used in the automotive field, e.g. for adjusting the volume or to select a gear setting P, R, N, D.

FIG. 2 shows a perspective view of the internal construction of the rotary switch 1 shown in FIG. 1, wherein the first part of the housing 7a has been removed. A plastic component 11 extends from the middle of the rotary switch 1, along the rotational axis 9 of the rotary switch 1, which connects to the knob 3. Numerous rings 13a, b, c are located concentrically about the rotational axis 9. These rings 13a, b, c collectively form a light screening element 15. The respective rings 13a, b, c form screening walls, wherein each screening wall 13 has openings 17. These screening walls 13, or the light screening element 15, are rotated with the knob 3. As a result, either an opening 17 or an opaque section 19 of the screening wall 13a, b, c is positioned in a specific radial direction facing away from the rotational axis 9 of the light switch, comprised of the first 13a, second 13b and third 13c screening wall, respectively. The openings 17 allow light to pass, but the material of the screening wall 13 itself is opaque. There is also a printed circuit board 21, connected thereto with connecting pins 23. The printed circuit board 21 is electrically connected to a communication interface of the rotary switch 1, which is not shown therein, by means of contact pins 25.

There are also three transmitter/receiver pairs 5a, b, c. The transmitter/receiver pairs 5a, b, c are attached to, or located on, the undersurface of the printed circuit board 21. Each of the transmitter/receiver pairs 5a, b, c have one transmitter and one receiver, wherein the transmitters and receivers are each located opposite one another, such that a light transmission path 27 is formed between the transmitters and the receivers. The transmitter/receiver pairs are positioned such that the light transmission paths 27 each span one of the screening walls 13a, b, c. Depending on the rotational position, the light transmission paths 27 of the transmitter/receiver pairs 5 are either blocked or opened by the screening wall 13. By way of example, if a user rotates the knob 3 such that an opening is positioned between the transmitter and the receiver, the light transmission path 27 remains unobstructed, and a light signal from the transmitter is received by the receiver. A corresponding electrical signal is then conveyed to an evaluation unit by the printed circuit board 21. If an opaque section 19 of a screening wall 13 is positioned between the transmitter and the receiver in a specific rotational position, then no light reaches the receiver.

The transmitter/receiver pairs 5, or the light screening element 15 are configured such that for each specific rotational position, a unique combination of receiver signals are generated. These shall be explained in greater detail in reference to FIG. 3. The sub-FIGS. 3a, 3b, 3c each show different rotational positions D, N, R of one embodiment of a rotary switch 1. Only the light screening element 15 and the respective transmitter/receiver pairs 5 are shown therein. Tables are also shown in FIGS. 3a, 3b, and 3c. The tables 29 show the respective electrical signals for the first transmitter/receiver pair 5a in three different rotational positions D, N and R, which are generated by the receiver. A 1 is shown thereby when a light signal is received by the receiver, and a 0 is shown when no light signal is received. In this manner, it can be determined whether there is an opening 17 in the screening wall 13 or an opaque section 19 of the screening wall 13 is located between the transmitter and the receiver. The corresponding electrical signal values for the transmitter/receiver pairs 5b and 5c are given analogously.

A first rotational position D is shown in FIG. 3a. In the first rotational position D, an opening 17 of the first screening wall 13a is located between the first transmitter/receiver pair 5a, or in the light transmission path 2a of the first transmitter/receiver pair. The third transmitter/receiver pair 5c is located radially behind the first transmitter/receiver pair in relation to the rotational axis 9. The outermost screening wall 13c also has an opening 17, as is the case for the innermost screening wall 13a, such that a light signal from the third transmitter reaches the third receiver. A 1 is thus entered in the table 29. In this first rotational position D, an opaque section 19 of the middle screening wall 13b is positioned such that it interrupts the light transmission path 27b of the second transmitter/receiver pair 5b. Consequently, a 0 is entered in the table 29 at this point. The second transmitter/receiver pair 5b is radially offset to the first transmitter/receiver pair 5a. The transmitter/receiver pairs 5a, b, c are thus compactly grouped on one side of the rotary switch 1. As a result, the printed circuit board 21 only has to cover this subsection of the rotary switch 1.

In FIG. 3b, the first transmitter/receiver pair 5a is blocked by the innermost screening wall 13a. The second transmitter/receiver pair 5b is unobstructed, in contrast, such that a light signal from the second transmitter will reach the second receiver. Consequently, a 1 is entered in the table at this point. In the third pair 5c, it is likewise the case that there is no opening 19 in the light transmission path 27c, such that for the third transmitter/receiver pair 5c, a 1 is also entered for the second rotational position N. The transmitter/receiver pairs 5 and the light screening element 15 are configured such that a unique combination of unobstructed or blocked light transmission paths 27 are obtained for each rotational position D, N, R.

A table 29 such as that shown in FIGS. 3a, b, c can be stored in a data storage unit in an evaluation unit of the rotary switch. When the rotational positions D, N, R of the rotary switch 1 are detected, the signals generated by the transmitter/receiver pairs 5 can thus be formed through a comparison with these stored tables. The rotational positions D, N, R are thus determined. In the third rotational position R, signals from the first and second transmitters 5a, b are allowed to pass, and the third transmitter/receiver pair 5c is blocked. The combination of received signals generated in this manner can be regarded as bit sequences. It is thus possible to analyze bit sequences representing a Hamming spacing between the respective rotational positions D, N, R. In this embodiment of a rotary switch 1, the Hamming spacing between the bit sequences representing different rotational positions is always 2. It is conceivable to provide more transmitter/receiver pairs 5, in order to obtain greater Hamming spacings. It is also conceivable to use more screening walls 13, or to use screening walls 13 that have not only transparent 17 or opaque 19 sections, but also only allow specific light frequencies to pass through them, and thus increase the possible number of combinations, and thus obtain a greater Hamming spacing between the individual rotational positions D, N, R. As a result, the reliability of a rotary switch 1 can be increased, in particular for use as a gear setting selection switch.

### REFERENCE SYMBOLS

1 rotary switch
3 rotational position detection device
5a, b, c first, second, third transmitter/receiver pairs
7a, b first, second housing parts
9 rotational axis
11 plastic component
13a, b, c first, second, third screening walls
15 light screening element
17 opening
19 opaque section
21 printed circuit board
23 fastening pin
25 contact pin
27 light transmission path
29 table
D, R, N rotational positions

1. A rotary switch for a motor vehicle that has a rotational position detection device, wherein the rotational position detection device has at least a first light-based transmitter/receiver pair, a second light-based transmitter/receiver pair, and a light screening element, wherein the first and second light-based transmitter/receiver pairs each have a light transmitter and a light receiver located opposite the light transmitter, such that a light transmission path is formed between each light transmitter and light receiver, wherein the light screening element determines the transmission properties of the respective light transmission paths based on the rotational positions of the rotary switch, wherein the first and second transmitter/receiver pairs are configured such that a first spacing extending between a midpoint of the first light transmission path of the first light-based transmitter pair and a rotational axis of the rotary switch differs from a second spacing extending between a midpoint of the second light transmission path of the second receiver pair and the rotational axis.

2. The rotary switch according to claim 1, wherein the light screening element can move in relation to the first and second light-based transmitter/receiver pairs (5a,b), wherein the relative movement is a rotational movement.

3. The rotary switch according to claim 1, wherein the first light-based transmitter/receiver pair and the second light-based transmitter/receiver pair are located along different radial directions in relation to the rotational axis.

4. The rotary switch according to claim 1, wherein the first light-based transmitter/receiver pair is located substantially radially between the second light-based transmitter/receiver pair and the rotational axis.

5. The rotary switch according to claim 1, wherein the light screening element has a first screening wall that is concentric to the rotational axis of the rotary switch, wherein the first screening wall at least partially encircles the rotational axis and determines the transmission property of the first light transmission path of the first light-based transmitter/receiver pair, depending on the rotational position, wherein the light screening element additionally has a second screening wall that is concentric to the rotational axis of the rotary switch, wherein the second screening wall at least partially encircles the rotational axis, and is at a different distance to the rotational axis than a distance of the first screening wall to the rotational axis, and the transmission property of the second light transmission path of the second light-based transmitter/receiver pair, is determined based upon the rotational position.

6. The rotary switch according to claim 5, wherein at least one of the first or second screening walls has sections with different transmission properties, in particular wherein one or both of the first or second screening wall has alternating transparent sections and opaque sections, wherein the alternating transparent sections affect the transmission properties of the respective light transmission paths corresponding to different rotational positions.

7. The rotary switch according to claim 6, characterized in that the light screening element is configured to determine the transmission properties of the respective first and second light transmission paths in that the first and second screening walls block or open the light transmission paths based on the rotational position such that each rotational position can be identified based on a unique combination of opened or blocked light transmission paths.

8. The rotary switch according to claim 7, wherein each unique combination can be represented by a bit sequence, characterized in that a Hamming spacing between the respective bit sequences represent combinations has a value of at least 2.

9. The rotary switch according to claim 1, wherein the light-based transmitter is configured to transmit an infrared light signal, and wherein each of the first and second light-based receiver is configured to receiver the infrared light signal.

10. A device for selecting a gear setting in a motor vehicle of claim 1 further comprising.
